(19) United States
(12) Patent Application Publication
(10) Pub. No.: US 2004/0254715 A1
(43) Pub. Date: Dec. 16, 2004

(54) In-vehicle email incoming notice unit and email transmission unit

(76) Inventor: Kazunao Yamada, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/863,783

(22) Filed: Jun. 8, 2004

(30) Foreign Application Priority Data
Jun. 12, 2003 (JP) 2003-167658

(51) Int. Cl. G06G 7/76

(52) U.S. Cl. 701/117

(57) ABSTRACT

A car navigation device mounted in a vehicle is capable of notifying a driver of an email incoming. Here, information relating to a traveling speed of the vehicle is retrieved. Based on the retrieved information, when the traveling speed of the vehicle is greater than a predetermined speed, notifying the driver of the email incoming is prohibited. This decreases a risk when the driver is notified of the email incoming while driving the vehicle.

### CROSS REFERENCE TO RELATED APPLICATIONS

This application is based on and incorporates herein by reference Japanese Patent Application No. 2003-167658 filed on Jun. 12, 2003.

### FIELD OF THE INVENTION

The present invention relates to an In-vehicle email incoming notice unit and an email transmission unit, being suitable for a car navigation device.

### BACKGROUND OF THE INVENTION

Conventionally, an email (electronic mail) is available in a navigation device mounted in a vehicle, using its email transmission/reception function; email incoming to the vehicle is notified to a user or driver.

However, when the vehicle travels at a high speed or moves closer to a vehicle ahead, notifying the driver of the email incoming distracts the driver from driving the vehicle. This may have an adverse affect on the safety of the driving.

### SUMMARY OF THE INVENTION

It is an object of the present invention to decrease a risk when a driver is notified of email incoming.

To achieve the above object, an in-vehicle email incoming notice unit mounted in a vehicle is provided with the following. Information relating to a risk when a driver of the vehicle is given a notice of email incoming is retrieved. The notice of email incoming to the driver is restricted in order to decrease the risk based on the retrieved information. This enables the in-vehicle email incoming notice unit to restrict notifying the driver of email incoming while the notice has an adverse affect on the safe driving.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram showing a schematic structure of an email incoming notice function in a vehicle according to an embodiment of the present invention;

FIG. 2 is a diagram showing a hardware structure of an email incoming notice function in a vehicle according to an embodiment of the present invention;

FIG. 3 is a flowchart diagram showing a program of email incoming notice according to the first embodiment of the present invention;

FIG. 4 is a flowchart diagram showing a program of email incoming notice according to the second embodiment of the present invention;

FIG. 5 is a flowchart diagram showing a program of email incoming notice according to the third embodiment of the present invention;

FIG. 6 is a diagram showing a hardware structure of a personal computer according to the fourth embodiment of the present invention;

FIG. 7 is a diagram showing a structure of an email including position information in its header portion;

FIG. 8 is a flowchart diagram showing a program of email transmission according to the fourth embodiment; and

FIG. 9 is a flowchart diagram showing a program of email incoming notice according to the fourth embodiment of the present invention.

### DETAILED DESCRIPTION OF THE PREFERRED EMBODIMENTS

(First Embodiment)

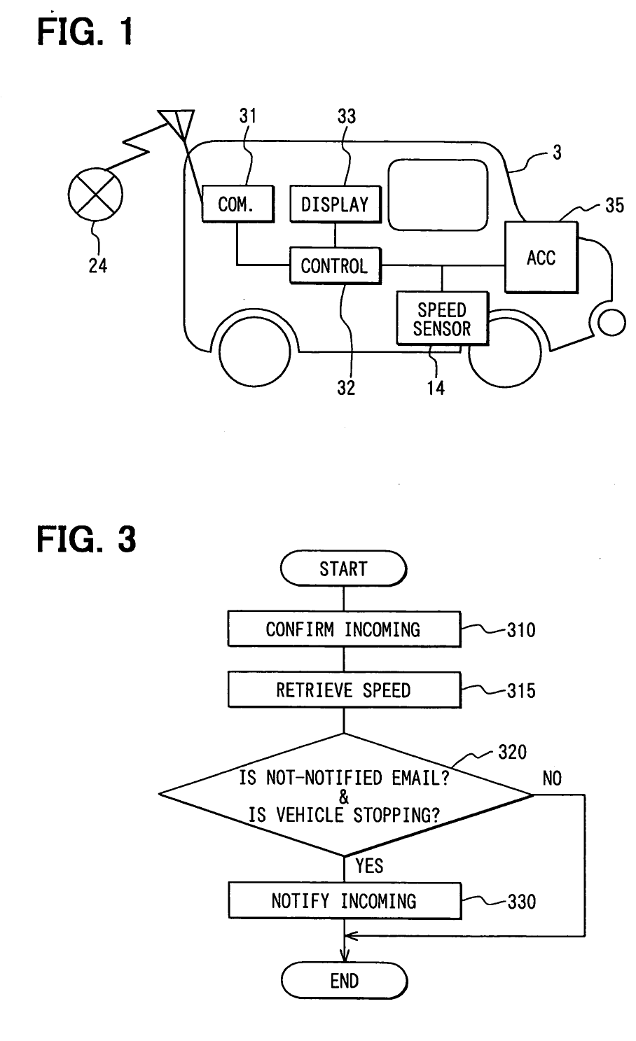

The present invention is directed to an email incoming notice provided in a vehicle as a first embodiment. As shown in FIG. 1, the vehicle 3 includes functions for the email incoming notice. A communications section 31 receives an email from an external network 24, by wireless communications, such as the Internet, outputting the email to a control section 32. The control section 32 causes a display section 33 to display an incoming notice of the inputted email by a speech, an image, or both of them. This enables a driver of the vehicle 3 to be notified of the email incoming. (In this specification, “a driver is notified of an email incoming” and “a driver is given an email incoming notice” are equivalently used.) Here, the control section 32 sometimes does not immediately notify the driver of the email incoming using the display section 33 depending on information inputted from a vehicle speed sensor 14, an adaptive cruise control (ACC) 35, etc.

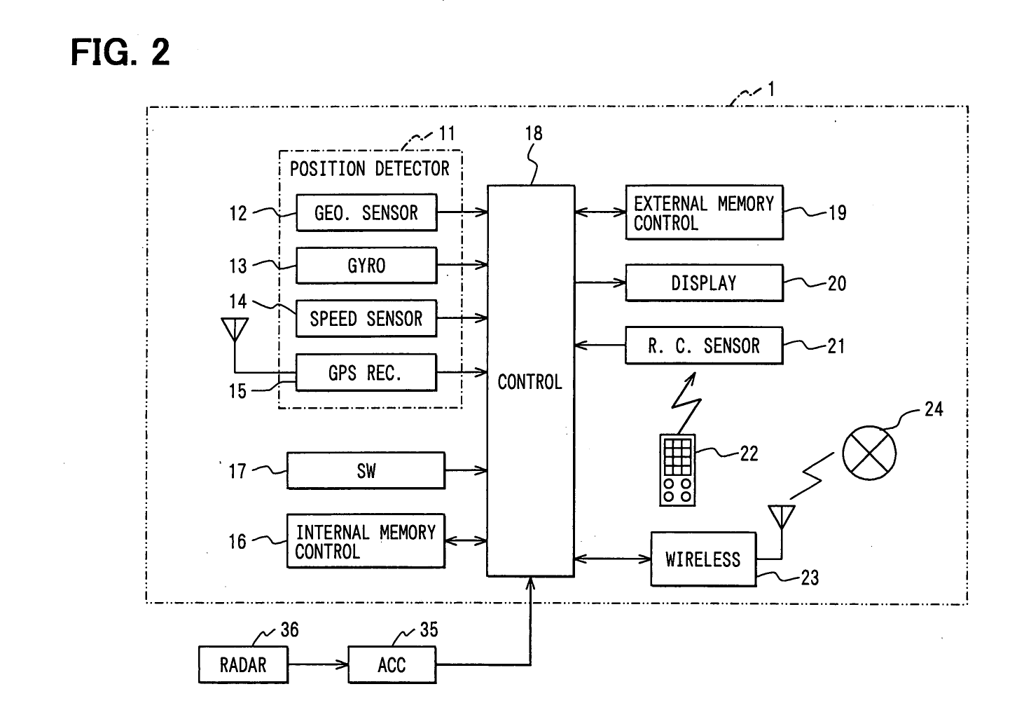

Further, the vehicle 3 includes hardware units as shown in FIG. 2. A car navigation device 1 is used as an in-vehicle email incoming notice unit. The car navigation device 1 includes a position detector 11, an internal memory control unit 16, a manipulation switch (SW) group 17, an external memory control unit 19, a display unit 20, a remote controller sensor 21, a wireless communications unit 23, and a control circuit 18 connected with the foregoing. The control circuit 18 of the car navigation device 1 receives a signal inputted from the ACC 35.

The display unit 20 includes a displaying screen such as a liquid crystal display and a speaker. Upon receiving an image signal inputted from the control circuit 18, the display unit 20 causes the screen to display the corresponding image. By contrast, upon receiving a speech signal, the display unit 20 causes the speaker to output the corresponding speech. The display unit 20 performs the function of the display section 33 in FIG. 1.

The manipulation switch group 17 is formed of push buttons surrounding the screen of the display unit 20, or a touch panel provided to be superimposed on the screen, outputting to the control circuit 18 signals based on user's pushing the pushing button or touching the touch panel.

The remote controller sensor 21 outputs to the control circuit 18 signals received from a remote controller 22 that sends wireless signals using infrared or the like based on user's manipulation.

The position detector 11 has a well-known geomagnetic sensor 12, a gyroscope 13, a vehicle speed sensor 14, and a GPS (Global Positioning System) receiver 15 for detecting a vehicle position based on radio waves from satellites, outputting to the control circuit 18 the current vehicle position based on these sensors 12 to 15. Since these sensors 12 to 15 have errors of individually different characteristics, they are used such that the errors are mutually supplemented. The position detector 11 can be arranged to include only a part of the above-described sensors 12 to 15 in accordance with accuracy. Further, it may be arranged to include a steering rotation sensor (not shown) or wheel sensors for the driving wheels (not shown).

The vehicle speed sensor 14 outputs to the control circuit 18 vehicle speed pulse signals detected from an engine ECU (not shown).

The internal memory control unit 16 controls data readout or data writing (if possible) with a non-volatile internal memory storage such as a hard disk drive (HDD). The information stored in the internal memory storage includes data for map-matching for enhancing a position detection accuracy, data including map data and landmark data, programs for operating the car navigation device 1, etc.

The external memory control unit 19 controls data readout or data writing (if possible) with an external memory storage such as a DVD-ROM, a memory stick, or a memory card. The information stored in the external memory storage includes additional data to the data stored in the internal memory storage of the internal memory control unit 16 that are the map-matching data, map data, landmark data, etc.

The wireless communications unit 23 applies amplification, frequency conversion, demodulation, A/D conversion, etc. to signals received via an antenna 25 by wireless communications, outputting a result to the control circuit 18. The wireless communications unit 23 applies D/A conversion, modulation, frequency conversion, amplification, etc. to data inputted by the control circuit 18, outputting a result to the antenna 19. The control circuit 18 thereby gives and receives data with an external network 24 such as the Internet via a base station of the wireless communications connecting with the external network 24. The wireless communications unit 23 performs the function of the communications section 31 in FIG. 1.

The control circuit 18 is a general computer including a CPU, a ROM, a RAM, a flash memory, an I/O, and bus line interconnecting the forgoing. The control unit 18 executes a program for operating the car navigation device 1, the program which is read out from the ROM or the external memory control unit 19. Here, the control circuit 18 reads out data from the ROM, RAM, or flash memory; writes data on the RAM or flash memory; gives and receives signals via the I/O with the position detector 11, the manipulation switch group 17, the external memory control unit 19, the display unit 20, the remote controller sensor 21, etc. The internal memory control unit 16, the control circuit 18, and the external memory control unit 19 perform the function of the control section 32 in FIG. 1.

A radar laser sensor (hereinafter “radar”) 36 is disposed in front of the vehicle 3, radiating a pulse laser light forward of the vehicle 3. The radar 36 then measures a period from radiating the light to receiving the reflected light from the vehicle ahead, and a Doppler variation of the reflected light. The radar 36 then computes a distance and a relative speed between the vehicle 3 and the vehicle ahead based on the measured items. The computed result is outputted to the ACC 35.

The ACC (adaptive cruise control) 35 controls the traveling of the vehicle 3 to maintain, up to the vehicle ahead, a following distance that is correlated with the speed of the vehicle ahead, based on the distance and relative speed with the vehicle ahead that are inputted from the radar 36. The ACC 35 is connected via an in-vehicle LAN such as CAN (Controller Area Network) with the vehicle speed sensor 14, an engine ECU (not shown) controlling engine rotation, a brake ECU controlling brake operation, shift ECU controlling a shift position, etc. The traveling control of the vehicle 3 is achieved by transmitting control signals via the in-vehicle LAN to the engine ECU, brake ECU, shift ECU, etc. The speed of the vehicle ahead is computed based on the speed of the vehicle 3 obtained from the vehicle speed sensor 14 via the in-vehicle LAN and the relative speed obtained from the radar 36. Here, a proportional coefficient between the speed of the vehicle ahead and the following distance can be set by the driver.

The ACC 35 transmits an alarming signal to the control circuit 18 repeatedly in need of calling the driver's attention when an actual following distance becomes shorter than a predetermined distance owing to any reason or when the following distance rapidly becomes shorter. Further, information outputted from the ACC 35 to the control circuit 18 is used for determining permitting or unpermitting of notifying the email incoming in the second embodiment that will be explained later.

Of the control circuit 18, detailed operations will be explained below. When the car navigation device 1 starts, the control circuit 18 reads and executes a boot program and operating program (hereinafter “OS”), controlling the hardware and the process based on the OS. The processes operating on the OS include a menu program, a route retrieving program, a map display program, etc.

The menu program displays a menu of the various programs operating on the OS, hierarchically with respect to a function or purpose, starting the program that the user selects from the menu. The menu display is executed by outputting the image data of the corresponding menu on the screen of the display unit 20. Selecting the program by the user is detected based on a signal inputted by the control circuit 18 through selecting manipulation (cursor shifting, determination button pushing, etc.) to the manipulation switch group 17 or remote controller 22 via the remote controller sensor 21. The route retrieving program forms a guidance route by automatically selecting the most proper route from a current position to a destination when a position is inputted, displaying the route on the display unit 20. The method for automatically selecting the most proper route includes the Dijkstra method.

The map display program overlaps additional data including the guidance route formed by the route retrieving program, with the map data read from the external memory control unit 19, and the vehicle current position mark based on the current position information inputted from the position detector 11, displaying them on the display unit 20.

Further, in this embodiment, the email incoming notice program is executed periodically (e.g., every 30 seconds) while the car navigation is operated. The process of the email incoming notice program will be explained below with reference to FIG. 3.

At Step 310, an email incoming is confirmed. In detail, an email sent to a predetermined addressee is retrieved by connecting with an email reception server (e.g., POP3 server, not shown) within the external network 24 via the wireless communications unit 23; the retrieved email is stored in the HDD controlled by the internal memory control unit 16. Here, the stored email is stored with a not-notified flag indicating that the email incoming is yet to be notified.

At Step 315, an output of the vehicle speed sensor 14 is retrieved; the traveling speed of the vehicle 3 is computed. Here, when the driver is notified of the email incoming while the vehicle is traveling, the driver may be distracted from paying attention to surrounding areas by the notification of the email incoming. The information relating to the vehicle speed can be thereby information relating to a risk when the driver is notified of the email incoming while driving.

At Step 320, it is determined whether the vehicle is stopping or not based on the vehicle speed computed at Step 315. In detail, when the computed speed is less than a threshold speed that is assumed that the vehicle is stopping, the vehicle is determined to be stopping. Otherwise, the vehicle is determined to be not stopping.

At Step 320, when the above-mentioned email with the not-notified flag is stored in the HDD and further the vehicle is determined to be stopping, the sequence advances to Step 330. Otherwise, the sequence is terminated.

At Step 330, the email incoming is notified to the driver. In detail, a speech indicating the email incoming is outputted through the speaker; or an image indicating the email incoming and an addresser or title of the email including the not-notified flag are displayed on the display unit 20. Thereafter, the not-notified flag is removed from the email in the HDD, which then terminates the process.

Further, when the driver notified of the email incoming manipulates the manipulation switch group 17 or remote controller 22 for starting the program enabling the incoming email to be displayed, the corresponding program is thereby activated. The incoming email is then displayed on the display unit 20, enabling the driver to confirm the contents of the incoming email.

Thus, when the email comes in and the vehicle 3 travels at a higher speed than the predetermined one, the process is terminated without executing the process at Step 330 through the determination process at Step 320. The notice of the email incoming to the driver can be thereby prohibited.

As a result, while driving the vehicle, the driver is not notified of the email incoming. The car navigation device 1 can thereby provide an email incoming notice function that enables reduction of the risk when the driver is notified of the email incoming while driving the vehicle.

(Second Embodiment)

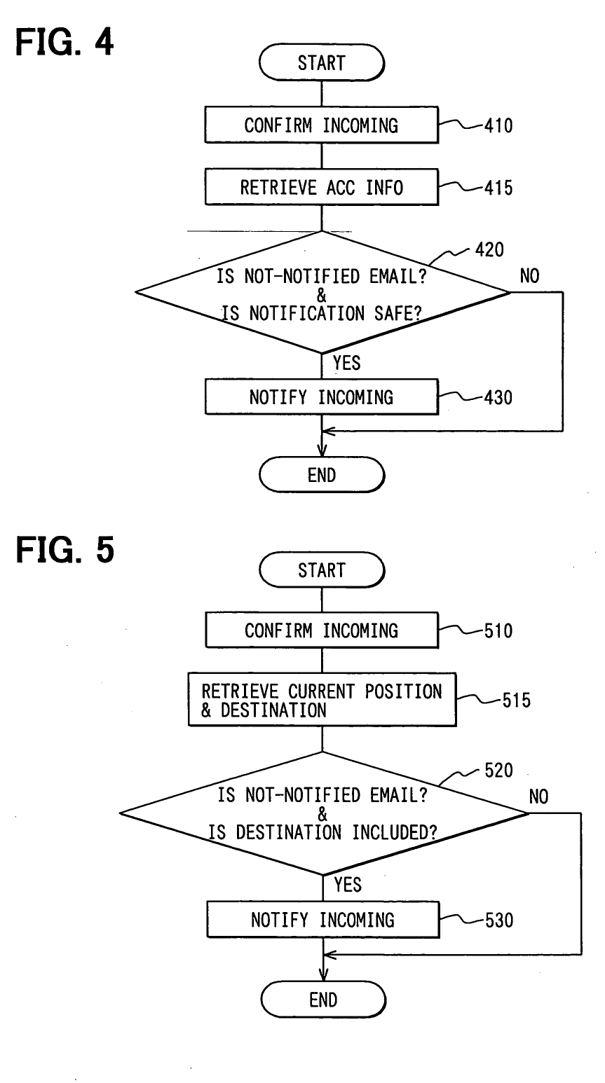

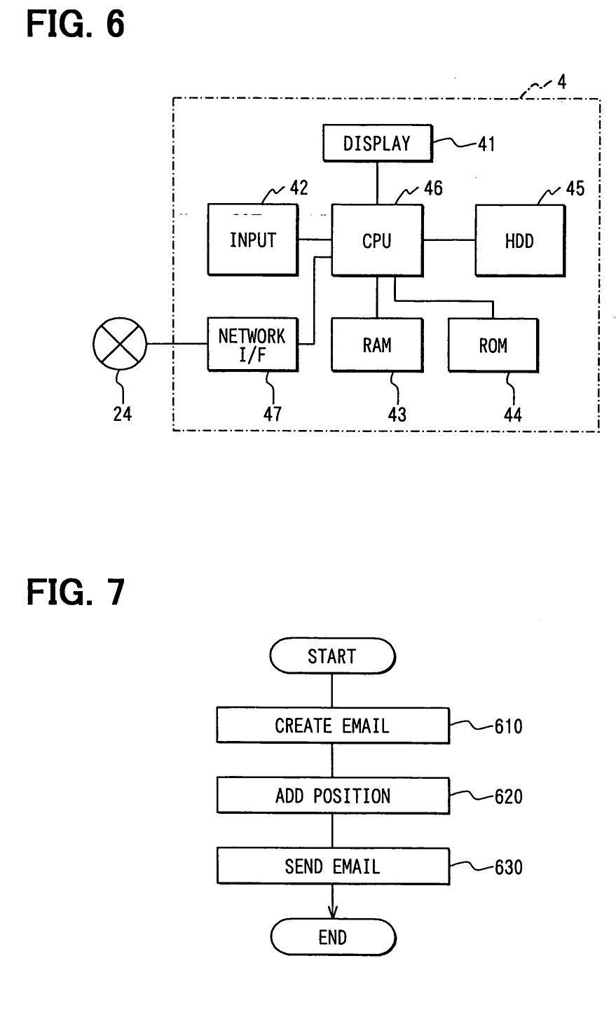

A second embodiment of the present invention is differentiated from the first embodiment in an email incoming notice program. The process of the email incoming notice program will be explained below with reference to FIG. 4.

The process at Steps 410, 430 is the same as that at Steps 310, 330 in the first embodiment.

At Step 415, when an output from the ACC 35 is present, the output is retrieved.

At Step 420, it is determined whether it is safe that the driver is notified of the email incoming based on the output retrieved from the ACC 35. In detail, when the ACC 35 repeatedly outputs an alarming signal, the email incoming notice is determined to be not safe. Otherwise, it is determined to be safe. Here, the alarming signal is the information relating to a risk when the drier is notified of the email incoming.

At Step 420, when the email with the not-notified flag is stored in the HDD and further the email incoming notice is determined to be safe, the sequence advances to Step 430. Otherwise, the process is terminated.

Thus, when the email comes in and the ACC 35 outputs the alarming signal, the process is terminated without executing the process at Step 430 through the determination process at Step 420. The notice of the email incoming to the driver can be thereby prohibited.

As a result, when the email incoming notice is determined to be not safe, the driver is not notified of the email incoming. The car navigation device 1 can thereby provide an email incoming notice function that enables reduction of the risk when the driver is notified of the email incoming while driving the vehicle.

(Third Embodiment)

A third embodiment of the present invention is differentiated from the first embodiment in an email incoming notice program. The process of the email incoming notice program will be explained below with reference to FIG. 5.

The process at Steps 510, 530 is the same as that at Steps 310, 330 in the first embodiment.

At Step 515, of the vehicle 3, the information of a destination and the information of a current position are retrieved. The destination is a position where the vehicle is to reach. The destination can be a destination inputted by the driver when the route retrieving program executes the route retrieving. Further, the destination cannot be the destination at the route retrieving program, but a fixed position such as a home garage separately designated through input to the manipulation switch group 17 by the driver for the email incoming program. Here, the information of the current position is retrieved in a form of information of longitude and latitude.

At Step 520, it is determined whether the vehicle arrives at the destination. In detail, the arrival to the destination is determined when a distance between the current position and the destination is less than a predetermined one (e.g., 100 m) using the information of the destination and information of the current position of the latitude and longitude retrieved at Step 515. Here, that the vehicle 3 arrives at the destination indicates that notifying the driver of the email incoming notice is safe. Here, the information of the current position of the vehicle 3 and information of the destination are information relating to a risk when the driver is notified of the email incoming.

At Step 520, when the email with the not-notified flag is stored in the HDD and further the email incoming notice is determined to be safe, the sequence advances to Step 530. Otherwise, the process is terminated.

Thus, when the email comes in and the vehicle does not arrive at the destination, the process is terminated without executing the process at Step 530 through the determination process at Step 520. The notice of the email incoming to the driver can be thereby prohibited.

As a result, when the email incoming notice is determined to be not safe, the driver is not notified of the email incoming. The car navigation device 1 can thereby provide an email incoming notice function that enables reduction of the risk when the driver is notified of the email incoming while driving the vehicle.

(Fourth Embodiment)

In a fourth embodiment, an email transmitting party includes position information in an email that is received by a receiving party of a vehicle 3. The receiving party of the vehicle 3 notifies a driver of the vehicle 3 of the email incoming only when the vehicle arrives at a position designated by the position information included in the email.

A personal computer 4 is an example as an email transmission unit according to the fourth embodiment of the present invention. The personal computer 4 includes a display 41, an input unit 42, a RAM 43, a ROM 44, an HDD 45, a CPU 46, a network interface (I/F) 47, etc.

The display 41 displays to a user an image corresponding to an image signal inputted from the CPU 46.

The input unit 42 includes a keyboard, a mouse, etc., to output to the CPU 46 according to a manipulation of the user.

The network interface 47 converts communications data sent to the personal computer 4 via the external network 24, into a format that the CPU 46 recognizes, outputting it to the CPU 46. The network interface 47 also processes transmission data inputted from the CPU 46 into data having a format following the communications protocol of the external network 24. The network interface 47 then sends the processed data to a given addressee within the external network 24 based on the timing following the communications protocol.

The CPU 46 is turned on by powering the personal computer 4, reading from the ROM 44 a given boot program to execute the program. The CPU 46 then reads from the HDD 45 an operating system (hereinafter “OS”) and other programs specified in the boot program to execute them, executing a start process. After completion of the start process, the CPU 46 executes, until shut-down of the power, the various programs stored in the HDD 45 as the process on the OS, based on a signal from the input unit 42 or schedule or the like previously specified by the OS. In the above-mentioned start process and the subsequent process, the CPU 46 receives a signal from the input unit 42 when needed, outputs an image signal to the display 41, controls data readout/writing with the RAM 43 and HDD 45, and executes data communications with the external network 24 via the network interface 47.

Next, an email transmission program will be explained with reference to FIG. 7. This program is stored in the HDD 45 and executed as one of the programs on the OS by being designated by a user using the input unit 42.

At Step 610, an email is created. In detail, an email creating field is shown on the display 41. Based on user's manipulation relating to the contents of the email using the input unit 42, the contents of the email are displayed in the field. Upon detecting manipulation corresponding to both of the completion of creating the email and the transmission of the email by the user using the input unit 42, the sequence advances to Step 620.

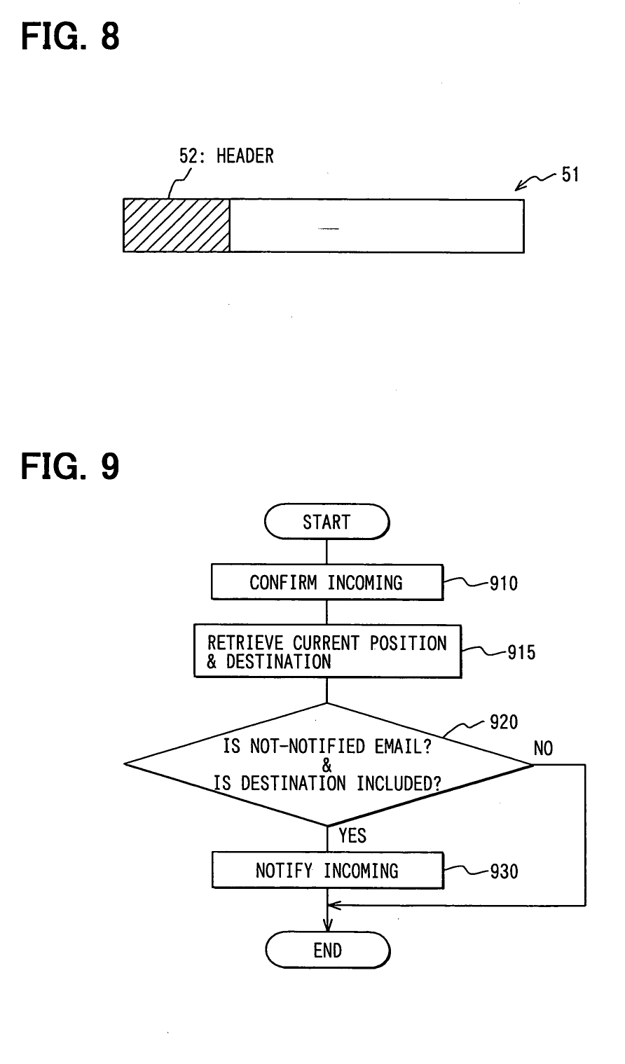

At Step 620, position information is added in the created email. The position information can be the longitude and latitude that are designated by the user, or the longitude and latitude that are previously designated according to an addressee of the email. Here, the position information can be added in a header portion 52 of the email 51, as shown in FIG. 8, or a given portion that is previously agreed by the sending party and receiving party.

At Step 630, the email including the position information is sent to the addressee of the email. In detail, the email is sent to an email transfer server (e.g., SMTP server, not shown) that is located within the external network 24 to transfer the email to the addressee.

Thus, when the addressee of the email is a given address assigned to the vehicle 3, the email is transferred from the email transfer server to the email reception server that receives the email having the given address as the addressee.

In this embodiment, the vehicle 3 of the email receiving party has difference only in its email incoming notice program from that of the third embodiment. The email incoming notice program will be explained with reference to FIG. 9.

The process at Steps 910, 920, 930 is the same as that at Steps 510, 520, 530 in the third embodiment.

At Step 915, similarly at Step 515, the information of a current position of the vehicle 3 is retrieved; further, the information of a destination is retrieved based on the position information when the position information is included in the header or the like within the received email.

Thus, when the position information is added in the email at Step 620 in FIG. 7, and when the determination process at Step 920 determines that the email comes in and that the vehicle does not arrive at the destination, the process is terminated without executing the process at Step 930. The notice of the email incoming to the driver can be thereby prohibited.

As a result, when the email incoming notice is determined to be not safe, the driver is not notified of the email incoming. The car navigation device 1 can thereby provide an email incoming notice function that enables reduction of the risk when the driver is notified of the email incoming while driving the vehicle.

(Others)

In the above embodiment, the ACC 35 that maintains a distance with the vehicle ahead is used for outputting an alarming signal as information relating to a risk when the driver is notified of the email incoming. However, the ACC 35 can be replaced with other devices such as STOP & GO device that has the same function as the ACC 35 has. The information outputted by the ACC 35 to the control circuit 18 can be information relating to a distance between the vehicle 3 and the vehicle ahead of the vehicle 3. Here, when the distance between the vehicle 3 and vehicle ahead is determined to be rapidly decreased at Step 420, the process at Step 430 is designed to be skipped without being executed.

In the above embodiments, an email is not only an email specified by RFC 822 or the like, but also emails following not-standardized specifications such as a “c mail” (trade mark) with an individual protocol used between cell phones.

It will be obvious to those skilled in the art that various changes may be made in the above-described embodiments of the present invention. However, the scope of the present invention should be determined by the following claims.

What is claimed is:

1. An in-vehicle email incoming notice unit provided in a vehicle, comprising:
information retrieving means for retrieving information relating to a risk when a driver of the vehicle is given a notice of email incoming; and
notice restricting means for restricting the notice of email incoming to the driver to decrease the risk based on the information retrieved by the information retrieving means.

2. The in-vehicle email incoming notice unit of claim 1,
wherein the information retrieving means retrieves the information relating to the risk from a vehicle travel control unit that maintains a distance between the vehicle and a vehicle ahead.

3. The in-vehicle email incoming notice unit of claim 1,
wherein the information relating to the risk includes information relating to a distance between the vehicle and a vehicle ahead.

4. An in-vehicle email incoming notice unit provided in a vehicle, comprising:
information retrieving means for retrieving information relating to a traveling speed of the vehicle; and
notice restricting means for restricting a notice of email incoming to the driver when the traveling speed of the vehicle is greater than a given speed based on the information retrieved by the information retrieving means.

5. An in-vehicle email incoming notice unit provided in a vehicle, comprising:
information retrieving means for retrieving information relating to an arrival of the vehicle to a position; and
notice restricting means for restricting a notice of email incoming to the driver when the vehicle does not reach the position based on the information retrieved by the information retrieving means.

6. The in-vehicle email incoming notice unit of claim 5,
wherein the information retrieving means designates a given position based on position information included in a given email that comes in, and
wherein, when the vehicle does not reach the given position, the notice restricting means restricts, to the driver, a notice of email incoming pertinent to the given email that includes the position information.

7. An email transmission unit that sends an email to an in-vehicle email incoming notice unit provided in a vehicle, comprising:
adding means for causing the email to include position information; and
transmitting means for transmitting the email that includes the position information, wherein, when the vehicle does not reach a position based on the position information included in the email that comes in, the in-vehicle email incoming notice unit restricts, to a driver of the vehicle, a notice of email incoming pertinent to the email.
